(19) United States
(12) Patent Application Publication
(10) Pub. No.: US 2026/0361456 A1
(43) Pub. Date: Nov. 12, 2026

(54) TECHNIQUES FOR DISTRIBUTED PROCESSING FOR A FORWARD ERROR CORRECTION ACCELERATOR

(71) Applicant: Intel Products IP LLC, Santa Clara, CA (US)

(72) Inventors: Brian P. JOHNSON, Forest Grove, OR (US); Andrey CHILIKIN, Limerick (IE); Patrick G. KUTCH, Tigard, OR (US)

(21) Appl. No.: 19/713,313

(22) Filed: Jun. 18, 2026

(51) Int. Cl. H04L 1/00

(52) U.S. Cl. CPC H04L 1/0047

(57) ABSTRACT

Examples include techniques associated with a network device to receive data packet traffic that includes a forward error correction (FEC) payload and cause the FEC payload to be processed by a FEC accelerator device directly coupled with the network device through a first interconnect interface. The example techniques also include causing FEC processed information generated by the FEC accelerator device to be routed to a memory maintained at a host computing platform. The FEC processed information to be routed through the first interconnect interface and through a second interconnect interface. The second interconnect interface configured to directly couple the network device to the computing platform.

### BACKGROUND

Some network packet processing architectures such as, but not limited to, virtualized radio access network (vRAN) architectures can incorporate use of discrete hardware accelerators for computationally intensive physical-layer functions, such as forward error correction (FEC). FEC is method for obtaining error control in data transmission in which a source can send redundant data and a destination recognizes a portion of the data that contains no apparent errors. When FEC is used in a vRAN architecture for data transmissions, a data transmission from a radio transmitter can be received and FEC-related data can be parsed from the data transmission and processed by the discrete hardware accelerators to detect and correct a limited number of errors. The discrete hardware accelerators can be referred to as FEC accelerators.

### BRIEF DESCRIPTION OF THE DRAWINGS

FIG. 1 illustrates an example system.

FIG. 2 illustrates an example of a more detailed view of the system.

FIG. 3 illustrates an example process flow.

FIG. 4 illustrates an example logic flow.

FIG. 5 illustrates an example network device.

FIG. 6 illustrates an example second system.

### DETAILED DESCRIPTION

Conventional virtualized Radio Access Network (vRAN) architectures or systems address computational demands of physical layer processing by combining a general purpose host central processing unit (CPU) with discrete hardware accelerators. In these architectures, fronthaul traffic from radio units can be received by a host Ethernet controller and processed by user space networking applications executing on cores of the host CPU. The host CPU can perform packet reception, header parsing, buffer management, scheduling, and selectively offload compute intensive functions such as forward error correction (FEC) to a dedicated FEC accelerator coupled to the host via a PCIe interconnect. After the FEC accelerator completes FEC encoding or decoding, results can be transferred back to memory maintained at or by the host CPU, where the host CPU resumes further signal processing and packet transmission.

The above-mentioned conventional vRAN architectures in which the host CPU can perform packet reception, header parsing, buffer management, scheduling and selectively offload compute intensive functions such as FEC to a dedicated FEC accelerator can introduce some limitations for which the example techniques described in this disclosure can eliminate or reduce. Host CPU resources can be heavily burdened by fronthaul packet reception and pre-processing, even though such processing is largely infrastructural and not directly related to higher layer radio functions. The host CPU can poll network interfaces, parse headers, manage buffer lifecycles, and orchestrate data transfers to FEC accelerators. These actions by the host CPU can reduce the availability of host CPU compute capacity for latency sensitive Layer 1 and Layer 2 processing.

As described in this disclosure, example techniques can reduce data movement inefficiencies that can arise from a placement of a FEC accelerator on a host CPU's interconnect hierarchy. The interconnects included in the host CPU's interconnect hierarchy can be arranged to operate according to a specification published by the Peripheral Component Interconnect Special Interest Group (PCI-SIG) to include the PCI Express (PCIe) Base Specification, Revision 7.0, published in June of 2025, hereinafter referred to as “the PCIe specification”. This host CPU interconnect hierarchy can be referred to as a host CPU's “PCIe hierarchy”. The placement of the FEC accelerator on the host CPU's PCIe hierarchy can result in an FEC payload data being moved multiple times across a host CPU's PCIe hierarchy and to a memory maintained or controlled by the host CPU (host memory). For example, FEC payload data can be first moved from the network interface to host memory, then from host memory to the FEC accelerator, and then back again. These redundant transfers can increase PCIe interconnect bandwidth consumption, increase memory bandwidth pressure, and also increase end-to-end latency. The example techniques of this disclosure can remove the FEC accelerator from directly coupling to the host CPU's PCI hierarchy and can cause the FEC payload data to not being moved multiple times across the host CPU's PCI hierarchy.

As described in this disclosure, example techniques include a mechanism for separating lightweight packet header processing from bulk FEC payload handling. In conventional vRAN architecture designs, both header parsing and FEC payload handling are performed by cores of the host CPU, even though header processing requires fine grained control logic and FEC payload data can be large, structured, and destined primarily for FEC accelerator processing. A tight coupling can exacerbate host CPU cache pollution, can increase CPU memory touches, and can limit scalability at higher fronthaul data rates. The example techniques of this disclosure can loosen the coupling by separating lightweight packet header processing from bulk FEC payload handling.

As described in this disclosure, a trusted boundary between infrastructure processing and tenant or application processing can be enforced. Hosting network termination, packet processing, and accelerator orchestration entirely on the host CPU can increase an attack surface and can also complicate isolation between infrastructure workloads and application workloads in multi-tenant, network packet processing architectures or deployments. The example techniques of this disclosure can enforce a trusted boundary by allowing the host CPU to indirectly configure or control FEC accelerators through a network device as opposed to directly configuring or controlling FEC accelerators.

As describe in this disclosure, example techniques can include a network device such an network packet processing unit that can be arranged to provide a packet processing architecture in which the network device can terminate traffic transmitted, for example, from a radio unit in a vRAN architecture and can orchestrate FEC offload to a locally attached FEC accelerator device. The network device can mediate FEC accelerator device configuration and authorize use of host CPU-allocated memory buffers to enable FEC processed data payloads to be delivered directly to host memory while maintaining the network device as the infrastructure trust boundary. These example techniques can shift infrastructure-level processing and control off/away from the host CPU without requiring changes to packet transmitters (e.g., radio units) or changes to hardware/silicon of FEC accelerator devices.

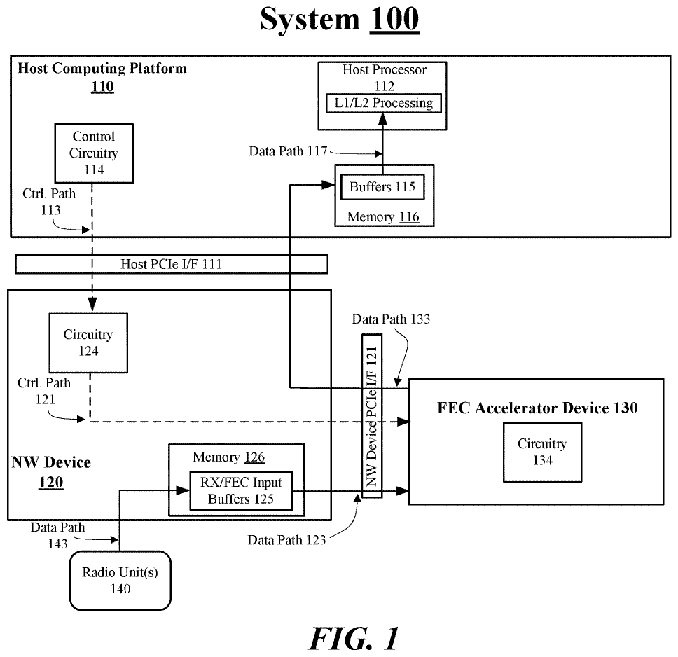

FIG. 1 illustrates an examples system 100. System 100, as shown in FIG. 1, includes a host computing platform 110, a network (NW) device 120, an FEC accelerator device 130, or one or more radio unit(s) 140. According to some examples, as shown in FIG. 1, a host PCIe interface (I/F) 111 can be arranged to communicatively couple elements of host computing platform 110 to NW device 120 and can be considered as part of host computing platform 110's PCIe hierarchy. Also, NW device PCIe I/F 121 can be arranged to communicatively couple elements of NW device 120 to FEC accelerator device 130 and can be considered as part of NW device 120's PCIe hierarchy. Host PCIe I/F 111 or NW device PCIe I/F 121 can be configured to operate in accordance with the PCIe specification.

In some examples, as shown in FIG. 1, host computing platform 110 can include a host processor 112 configured to perform physical layer (Layer 1 (L1)) or data link layer (L2) packet processing. For example, for packets received from radio unit(s) 140 through NW device 120 and for processed FEC payload information generated by FEC accelerator device 130 using FEC payloads included in the received packets. Host processor 112 can include a multi-core processor such as, but not limited to, a multi-core CPU. Host computing platform 110 can also include a control circuitry 114 to provide control and configuration data to circuitry 124 of NW device 120 via control path 113 routed through host PCIe I/F 111. As described in more detail below, the control and configuration data received from control circuitry 114 by circuitry 124 can provide directions or guidance over control path 122 and through NW device PCIe I/F 121 to configure FEC accelerator device 130 for FEC payload processing for the packets received in receive (RX)/FEC input buffers 125 of NW device 120's memory 126 from radio unit(s) 140 and direct memory access (DMA) operations to store processed FEC payload information to buffers 115 of memory 116 at host computing platform 110. Host processor 112 can then obtain the processed FEC payload information from buffers 115 via data path 117 for subsequent L1/L2 processing. The packets received from radio unit(s) 140, as shown in FIG. 1, can be received in RX/FEC input buffers 125 via data path 143.

According to some examples, circuitry 124 can include logic and/or features configured to terminate this fronthaul link routed via data path 143, parse packet headers, and identify FEC payloads to be processed by FEC accelerator device 130. The FEC payloads, for example, are routed via data path 123 through NW device PCIe I/F 121 to FEC accelerate device 130 for circuitry 134 at FEC accelerator device 130 to process. Processed FEC payload information generated based on the FEC payloads can then be directly loaded (e.g., via DMA operations) to buffers 115 of memory 116 at host computing platform 110 via data path 133 routed through NW device PCIe I/F 121. Other than provide configuration and control information to configure FEC accelerator device 130, host computing platform 110 is not involved in the receiving, packet header parsing, FEC processing of FEC payloads, or routing of processed FEC payload information to buffers 115 of memory 116.

According to some examples, control circuitry 114 can be a core of host processor 112 or can be a separate circuitry from host processor 112, resident on a separate package and/or chip from host processor 112. For example, control circuitry 114 can be at least part of an application specific integrated circuit (ASIC) or a field programmable gate arrays (FPGA).

In some examples, circuitry 124 at NW device 120 can be included in processing circuitry or processing elements maintained on NW device 120. This processing circuitry or processing elements can include, but are not limited to, a CPU and/or a graphics processing unit (GPU) or can include one or more ASICs, one or more FPGAs or any combination of a CPU, GPU, ASIC or FPGA. NW device 120 can also be referred to as an infrastructure processing unit (IPU). NW device 120 can also be referred to as a data processing unit (DPU).

According to some examples, circuitry 134 of FEC accelerator device 130 can include circuitry and/or logic arranged to process FEC payloads received via data path 123 and to directly store processed FEC payload information to buffers 115 of memory 116 via data path 133. Circuitry 134 can be included in one or more ASICs or FPGAs configured for FEC payload processing and directly storing processed FEC payload information to buffers 115 of memory 116 via data path 133.

In some examples, memory 116 at host computing platform 110 or memory 126 at NW device 120 can include volatile or non-volatile types of memory. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM). Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), magnetoresistive random access memory (MRAM) that incorporates memristor technology, spin transfer torque MRAM (STT-MRAM), or a combination of any of the above.

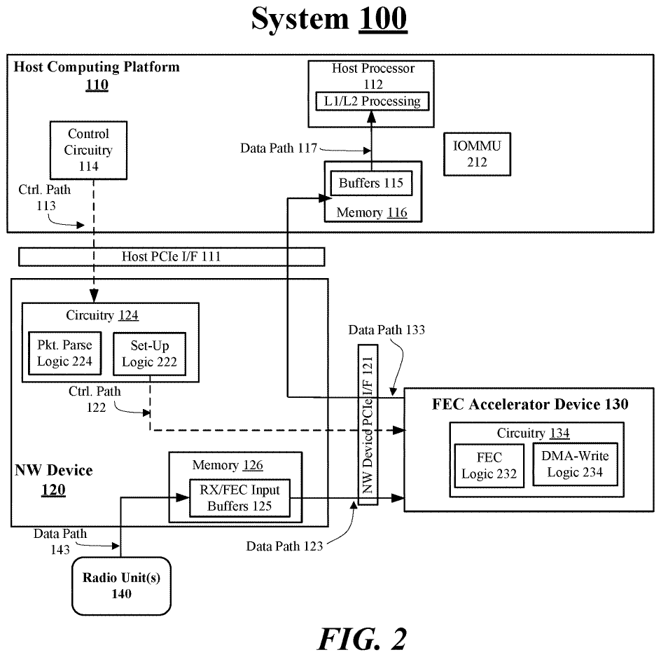

FIG. 2 illustrates an example of a more detailed view of system 100. As shown in FIG. 2, system 100 includes host computing platform 110, NW device 120, FEC accelerator device 130 and radio unit(s) 140. According to some examples, as shown in FIG. 2, circuitry 124 of NW device 124 includes a set-up logic 222 and a packet parse logic 224 and circuitry 134 of FEC accelerator device includes an FEC logic 232 and a DMA-write logic 234. For these examples, fronthaul data packet traffic from radio unit(s) 140 can be received directly via data path 143 by NW device 120 and DMA-written into RX/FEC input buffers 125. NW device 120 can therefore terminate a data path with radio unit(s) 140. Also, packet parse logic 224 of circuitry 124 can be configured to parse packet headers of the fronthaul data packet traffic and identify FEC payloads to be routed from RX/FEC input buffers 125 to FEC accelerator device 130 via data path 123 through NW device PCIe I/F 121. For example, if the fronthaul data packet traffic were formatted according to the Common Public Interface; eCPRI Interface Specification, version 2.0, published in May of 2019, the packet headers can be parsed by filtering on eCPRI Ethertype (e.g., eCPRI Ethertype (0xAEFE)) to identify an FEC payload to be processed by FEC accelerator device 130 and to indicate to FEC accelerator device 130 were the FEC payload to be processed can be obtained from RX/FEC input buffers 125. The termination of the data path (directly receiving data packet traffic from radio unit(s) 140), parsing of packet headers and routing of FEC payloads by NW device 120 can occur without involvement of host computing platform 110 or host processor 112.

In some examples, set-up logic 222 of circuitry 124 can a function as a type of infrastructure trust boundary and can be configured to directly control configuration of FEC accelerator device 130 based, at least in part, on control and configuration information received from control circuitry 114 via control path 113 routed through host PCIe I/F 111. For these examples, set-up logic 222 can directly control configuration of FEC accelerator device 130 via control path 122 routed through NW device PCIe I/F 121. In this way, only NW device 120 is able to directly control the configuration of FEC accelerator device 130 via a local PCIe interconnect hierarchy routed through NW device PCIe I/F 121. Set-up logic 222 of circuitry 124 can serve as a proxy for configuration of FEC accelerator device 130 and can work in cooperation with FEC logic 232 of circuitry 134 to configure a queue setup, descriptor installation, and invocation of FEC operations. Serving as a proxy for configuration of FEC accelerator device 130 can also allow set-up logic 222 of circuitry 124 to enforce policy, isolation, or authorization for access to FEC accelerator device 130, while preventing a host such as host computing platform 110 or a host processors such as host processor 112 from directly controlling FEC accelerator device 130.

According to some examples, set-up logic 222 of circuitry 124 can receive configuration information from control circuitry 114 via control path 113. For these examples, the configuration information can be for one or more allocated memory buffers maintained at host computing platform 110 for receiving processed FEC payload information (e.g., FEC decoded/recovered data). The allocated memory buffers, for example, can be buffers 115 included in memory 116. The configuration information for the allocated memory buffers can include address translations, for example, provided by an input/output memory management unit (IOMMU) 212 at host computing platform 110. The configuration information describing these allocated buffers can also include address ranges and access permissions and/or DMA-write authorizations to these address ranges. Set-up logic 222 of circuitry 124 can validate this configuration information, apply relevant policies for configuring FEC accelerator device 130 and then configure or program FEC accelerator device 130 to enable circuitry and/or logic of circuitry 134 of FEC accelerator device 130 (e.g., DMA-write logic 234) to execute DMA-write operations or actions to these DMA-authorized address ranges of allocated buffers.

In some examples, FEC processing of FEC payloads can be executed by logic and/or features of circuitry 134 of FEC accelerator device 130 such as FEC logic 232. FEC processing, for example, can include decoding FEC information included in FEC payloads obtained from RX/FEC input buffers 125 via data path 123 and through NW device PCIe I/F 121. Decoding the FEC information can be based on a variety of error-correcting codes such as, but not limited to, Bose-Chaudhuri-Hocquenghem (BCH), Hamming, low-density parity check (LDPC), Reed-Solomon (RS), or Turbo. The decoded FEC information can then be used to recover/correct errors in data packets received from radio unit(s) 140.

According to some examples, after FEC processing is completed by FEC logic 232, logic and/or features of circuitry 134 of FEC accelerator device 130 such as DMA-write logic 234 can DMA-write processed information from FEC payloads (e.g., recovered/correct errors in data packets) directly to authorized memory addresses ranges of buffers 115 that were configured as mentioned previously. For these examples, FEC logic 232 can directly DMA-write the processed information via data path 133 that is routed first through NW device PCIe I/F 121 and then through Host PCIe I/F 111 to be received to the authorized memory addresses ranges of buffers 115. An intermediate staging of post-processed information from FEC payloads in memory maintained at NW device 120 is not needed via this approach that uses data path 117 to reach buffers 115. Host processor 112 of host computing platform 110 can access buffers 115 via data path 117 to consume the post-processed information from FEC payloads for L1/L2 processing without a need for host computing platform 110 to participate in termination of data packets received from packet transmitters such as radio unit(s) 140 or a need for accelerator orchestration of FEC accelerator device 130 by host processor 112 or host computing platform 110.

In some examples, RX/FEC input buffers 125 to receive data packets from radio unit(s) 140 can be moved from memory 126 to memory 116 at host computing platform 110. For these examples, RX/FEC input buffers 125 can be host-allocated by control circuitry 114 in a similar manner as mentioned above for buffers 115. In other words, set-up logic 222 of circuitry 124 of NW device 120 can receive configuration information to program FEC accelerator device 130 to access FEC payloads to be processed from memory address ranges of memory 116 arranged to maintain buffers similar to RX/FEC input buffers 125.

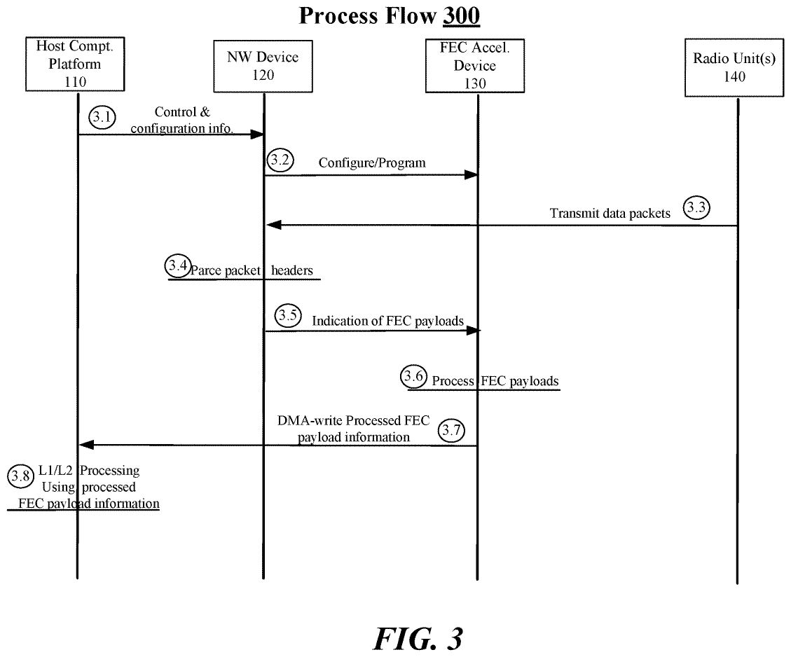

FIG. 3 illustrates an example process flow 300. According to some examples, process flow 300 shows an example of a NW device that can be arranged to provide an NW device-centric processing architecture in which the NW device can terminate packet traffic transmitted from, for example, a radio unit in a vRAN architecture, and can orchestrate FEC payload processing offload to a locally attached FEC accelerator device. For these examples, elements of system 100 as shown in FIGS. 1-2 such as host computing platform 110, NW device 120, FEC accelerator device 130 or radio unit(s) 140 can implement at least portions of process flow 300. Also, sub-elements of these elements of system 100 such as control circuitry 114, circuitry 124 or circuitry 134 can include logic and/or features to facilitate implementation of at least portions of process flow 300. Although example process flow 300 is not limited to implementation by these elements or sub-elements of system 100.

In some examples, process flow 300, at 3.1, hot platform 110 sends control and configuration information to NW device 120. For these examples, control circuitry 114 of host computing platform 110 sends the control and configuration information to circuitry 124 of NW device 120. The configuration information can include configuring/programing instructions for NW device 120 to configure/program FEC accelerator device 130. The configuration information can also indicate allocated memory address ranges corresponding to buffers 115 of memory 116 at host platform 100 for use by FEC accelerator device 130 to DMA-write information associated with FEC processed payloads. The configuration information to be received via control path 113 routed through host PCIe I/F 111.

According to some examples, process flow 300, at 3.2, NW device 120 configures/programs FEC accelerator device 130. For these examples, set-up logic 222 of circuitry 124 configures/programs FEC accelerator device 130 based, at least in part, on the configuration information received from host computing platform 110. As part of the configuring/programming, DMA-write logic 234 of circuitry 134 of FEC accelerator device 130 is provided information to enable DMA-write operations to buffers 115 for FEC processed payload information. Set-up logic 222 can configure/program FEC accelerator device 130 via control path 122 routed through NW device PCIe I/F 121.

In some examples, process flow 300, at 3.3, radio unit(s) 140 transmit data packets with associated FEC payloads to NW device 120. For these examples, the data packets are received in RX/FEC input buffers 125 of memory 126 at NW device 120 as fronthaul data packet traffic.

According to some examples, process flow 300, at 3.4, NW device 120 parses packet headers of the data packets received from radio unit(s) 140. For these examples, packet parse logic 224 of circuitry 124 at NW device 120 parses the packet headers to identify FEC payloads for processing by FEC accelerator device 130.

In some examples, process flow 300, at 3.5, NW device 120 sends an indication to FEC accelerator device 130 that FEC payloads to be processed are located in RX/FEC input buffers 125. For these examples, FEC logic 232 of circuitry 134 at FEC accelerator device 130 can be configured to obtain or receive the FEC payloads via data path 123 through NW device PCIe I/F 121.

According to some examples, process flow 300, at 3.6, FEC accelerator device 130 can process the FEC payloads. For these examples, FEC logic 232 of circuitry 134 can process the FEC payloads by decoding FEC information included in the FEC payloads (e.g., based on BCH, Hamming, LDPC, RS or Turbo error-correcting codes).

In some examples, process flow 300, at 3.7, FEC accelerator device 130 DMA-writes processed FEC payload information to host computing platform 110. For these examples, DMA-write logic 234 of circuitry 134 at FEC accelerator device 130 DMA-writes the processed FEC payload information to buffers 115 of memory 116 at host computing platform 110 via data path 133 that is routed first through NW device PCIe I/F 121 and then is routed through host PCIe I/F 111. The DMA-write operations, for example, are to the allocated memory address ranges corresponding to buffers 115 of memory 116 at host platform 100 for use by FEC accelerator device 130 to DMA-write information associated with FEC processed payload information as mentioned above at 3.2.

In some examples, process flow 300, at 3.8, host computing platform 110 can perform or execute L1/L2 processing using the FEC processed payload information. For these examples, host processor 112 of host computing platform 110 can access buffers 115 via data path 117 to consume the FEC processed payload information. Process flow 300 then comes to an end.

Included herein is a logic flow representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware examples, a logic flow can be implemented by computer executable instructions stored on at least one non-transitory computer readable medium or machine readable medium, such as an optical, magnetic or semiconductor storage. The examples are not limited in this context.

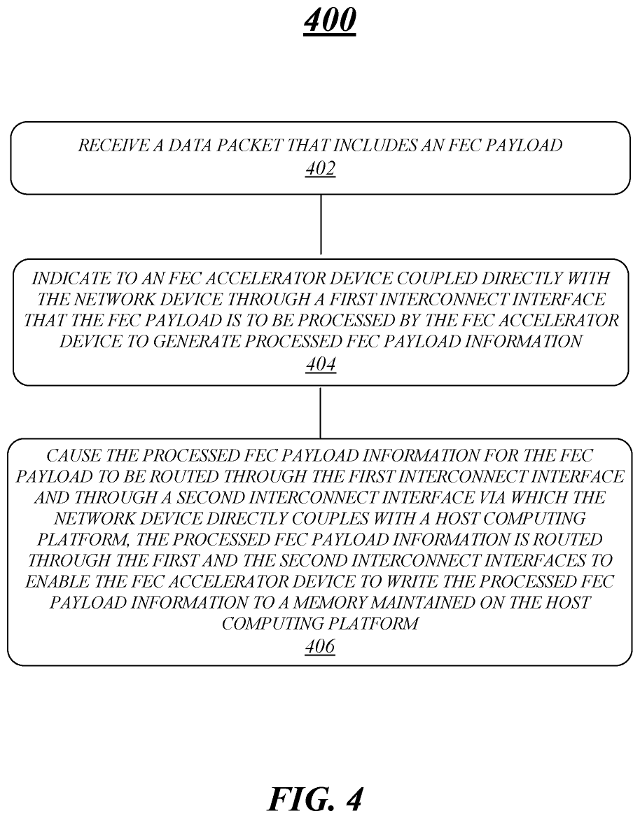

FIG. 4 illustrates an example logic flow 400. Logic flow 400 can be representative of some or all of the operations executed by one or more circuitry, logic and/or features described herein, such as logic and/or features of circuitry 124 such as, but not limited to packet parse logic 224 or set-up logic 222. Logic flow 400 can represent how circuitry of a NW device such as NW device 120 can terminate fronthaul traffic transmitted from a radio unit (e.g., among radio unit(s) 140) and can orchestrate FEC payload processing offload to a locally attached FEC accelerator device (e.g., FEC accelerator device 130) and route processed FEC payload information to a memory maintained at a host computing platform (e.g., memory 116 at host computing platform 110).

In some examples, as shown in FIG. 4, logic flow 400 at block 402 can receive a data packet that includes an FEC payload. For these examples, NW device 120 can receive the data packet in RX/FEC input buffers 125 of memory 126 maintained at NW device 120.

According to some examples, as shown in FIG. 4, logic flow 400 at block 404 can indicate to an FEC accelerator device coupled directly with the network device through a first interconnect interface that the FEC payload is to be processed by the FEC accelerator device to generate processed FEC payload information. For these examples, packet parse logic 224 of circuitry 124 at NW device 120 can provide the indication to FEC accelerator device 130. The indication to point to RX/FEC input buffers 125 for where FEC accelerator device 130 can obtain the FEC payload to be processed.

In some examples, as shown in FIG. 4, logic flow 400 at block 406 can cause the processed FEC payload information for the FEC payload to be routed through the first interconnect interface and through a second interconnect interface via which the network device directly couples with a host computing platform. The processed FEC payload information is routed through the first and the second interconnect interfaces to enable the FEC accelerator device to write the processed FEC payload information to a memory maintained on the host computing platform. For these examples, the processed FEC payload information is routed through NW device PCIe I/F 121 and then host PCIe I/F 111 to be DMA-written to memory 116 at host computing platform 110.

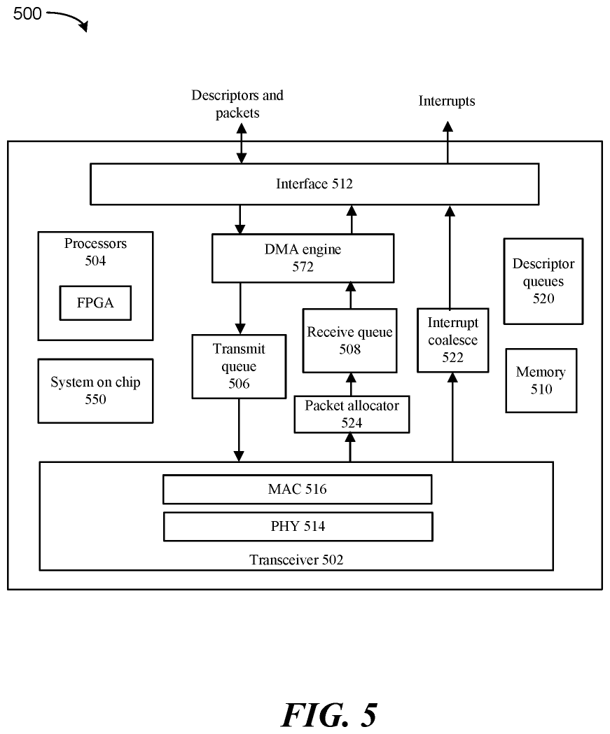

FIG. 5 illustrates an example network device 500. In some examples, circuitry of network device 500 (e.g., at least processors 504 or system on chip (SoC) 550) can terminate fronthaul traffic transmitted from a radio unit and can orchestrate FEC payload processing offload to a locally attached FEC accelerator device and route processed FEC payload information to a memory maintained at a host computing platform, as described herein. In some examples, network device 500 can be implemented as a network interface controller, network interface card, a host fabric interface (HFI), or host bus adapter (HBA), and such examples can be interchangeable. Network device 500 can be coupled to one or more servers using a bus, PCIe, CXL, or Double Data Rate (DDR). Network device 500 may be embodied as part of a system-on-a-chip (SoC) that includes one or more processors, or included on a multichip package that also contains one or more processors.

Some examples of network device 500 can be configured as an IPU. Network device 500 can also be configured as a DPU. An xPU can refer at least to an IPU, DPU, GPU, GPGPU, or other processing units (e.g., accelerator devices). An IPU or a DPU can include a network interface with one or more programmable or fixed function processors to perform offload of operations that could have been performed by a host CPU. The IPU or the DPU can include one or more memory devices. In some examples, the IPU or the DPU can perform virtual switch operations, manage storage transactions (e.g., compression, cryptography, virtualization), and manage operations performed on other IPUs, DPUs, servers, or devices.

Network device 500 can include transceiver 502, processors 504, transmit queue 506, receive queue 508, memory 510, and bus interface 512, and DMA engine 552. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 514 and media access control (MAC) circuitry 516. PHY circuitry 514 can include encoding and decoding circuitry (not shown) to encode and decode data packets according to applicable physical layer specifications or standards. MAC circuitry 516 can be configured to assemble data to be transmitted into packets, that include destination and source addresses along with network control information and error detection hash values.

Processors 504 can perform operations of terminating fronthaul traffic transmitted from a radio unit (not shown in FIG. 5) and can orchestrate FEC payload processing offload to a locally attached FEC accelerator device (not shown in FIG. 5) and route processed FEC payload information to a memory maintained at a host computing platform (not shown in FIG. 5).

Processors 504 can be any a combination of a: processor, core, GPU, FPGA, ASIC, or other programmable hardware device that allow programming of network device 500. For example, a “smart network interface” can provide packet processing capabilities in the network

### Interface Using Processors 504.

Processors 504 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 504, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 524 can provide distribution of received packets for processing by multiple CPUs or cores using timeslot allocation described herein or RSS. When packet allocator 524 uses RSS, packet allocator 524 can calculate a hash or make another determination based on contents of a received packet to determine which CPU or core is to process a packet.

Interrupt coalesce 522 can perform interrupt moderation whereby network interface interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 552 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be any type of volatile or non-volatile memory device and can store any queue or instructions used to program network interface 500. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Bus interface 512 can provide an interface with host device (not depicted). For example, bus interface 512 can be compatible with PCI, PCI Express, PCI-x, Serial ATA, and/or USB compatible interface (although other interconnection standards may be used).

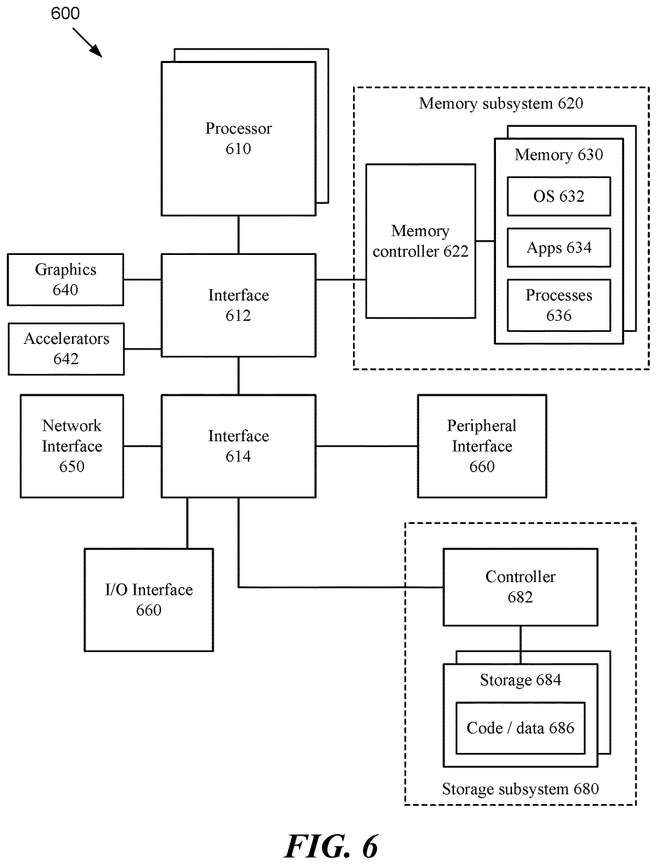

FIG. 6 illustrates an example system 600. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 610 can include multiple processors and multiple processors can be embodied as processor sockets.

In one example, system 600 includes interface 612 coupled to processor 610, which can represent a higher speed interface or a high throughput interface for system components, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610 and/or network interface 650. For example, an accelerator among accelerators 642 can provide FEC payload processing, data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the artificial intelligence (AI) model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container (e.g., Docker container), microservice, processor, or other software. Various examples can perform an application composed of microservices, where a microservice runs in its own process and communicates using protocols (e.g., application programming interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers, workstations, or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, IPU, or DPU.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

One or more aspects of at least one example can be implemented by representative instructions stored on a machine-readable medium which represents various logic within the processor, which when read by a machine causes the machine to fabricate logic to perform the techniques described herein. Such representations, known as “IP cores” can be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, various examples also include non-transitory, tangible machine-readable media containing instructions or containing design data, such as Hardware Description Language (HDL), which defines structures, circuits, apparatuses, processors and/or system features described herein. Such examples may also be referred to as program products.

In some cases, an instruction converter can be used to convert an instruction from a source instruction set to a target instruction set. For example, the instruction converter can translate (e.g., using static binary translation, dynamic binary translation including dynamic compilation), morph, emulate, or otherwise convert an instruction to one or more other instructions to be processed by the core. The instruction converter can be implemented in software, hardware, firmware, or a combination thereof. The instruction converter may be on processor, off processor, or part on and part off processor.

Various examples can be implemented using hardware elements, software elements, or a combination of both. In some examples, hardware elements can include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements can include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

The following examples pertain to additional examples of technologies disclosed herein.

Example 1. An example network device can include a network interface configured to receive a data packet that includes a FEC payload. The network device can also include a first interconnect interface to couple with a host computing platform. The network device can also include a second interconnect interface to couple with a FEC accelerator device. The network device can also include circuitry configured to indicate to the FEC accelerator device through the second interconnect interface that the FEC payload is to be processed by the FEC accelerator device to generate processed FEC payload information. The circuitry can also be configured to cause the processed FEC payload information for the FEC payload to be routed through the second interconnect interface and through the first interconnect interface. The processed FEC payload information can be routed through the second and the first interconnect interfaces to enable the FEC accelerator device to write the processed FEC payload information to a memory maintained on the host computing platform.

Example 2. The network device of example 1 can also include the circuitry configured to receive configuration information sent from control circuitry of the host computing platform through the first interconnect interface. The circuitry can also cause the FEC accelerator device to be configured based on the configuration information to enable the FEC accelerator device to write the processed FEC payload information to the memory maintained on the host computing platform.

Example 3. The network device of example 2, the configuration information can indicate allocated memory from among the memory maintained on the host computing platform to which the processed FEC information is to be written via a direct memory access operation.

Example 4. The network device of example 1, the data packet can be received from a radio unit, and the circuitry can be further configured to cause the data packet to be received in a memory maintained at the network device.

Example 5. The network device of example 1, the first and the second interconnect interfaces can be configured to operate according to a PCIe specification.

Example 6. The network device of example 1, the network device can be an IPU or a DPU.

Example 7. An example method comprising: receiving, at a network device, a data packet that includes a FEC payload. The method can also include indicating to an FEC accelerator device coupled directly with the network device through a first interconnect interface that the FEC payload is to be processed by the FEC accelerator device to generate processed FEC payload information. The method can also include causing the processed FEC payload information for the FEC payload to be routed through the first interconnect interface and through a second interconnect interface via which the network device directly couples with a host computing platform. The processed FEC payload information can be routed through the first and the second interconnect interfaces to enable the FEC accelerator device to write the processed FEC payload information to a memory maintained on the host computing platform.

Example 8. The method of example 7 can also include receiving, at the network device, configuration information sent from control circuitry of the host computing platform through the second interconnect interface; and causing the FEC accelerator device to be configured based on the configuration information to enable the FEC accelerator device to write the processed FEC payload information to the memory maintained on the host computing platform.

Example 9. The method of example 8, the configuration information can indicate allocated memory from among the memory maintained on the host computing platform to which the processed FEC information is to be written via a direct memory access operation.

Example 10. The method of example 7, receiving the data packet can include receiving the data packet from a radio unit and causing the data packet to be received in a memory maintained at the network device.

Example 11. The method of example 7, the first and the second interconnect interfaces are configured to operate according to a PCIe specification.

Example 12. The method of example 7, the network device comprises an IPU or a DPU.

Example 13. An example at least one machine readable medium can include a plurality of instructions that in response to being executed by a system can cause the system to carry out a method according to any one of examples 7 to 12.

Example 14. An example apparatus can include means for performing the methods of any one of examples 8 to 12.

Example 15. An example at least one machine readable medium can include a plurality of instructions that in response to being executed by circuitry of a network device can cause the circuitry to receive a data packet that includes a FEC payload. The instructions can also cause the circuitry to indicate to an FEC accelerator device coupled directly with the network device through a first interconnect interface that the FEC payload is to be processed by the FEC accelerator device to generate processed FEC payload information. The instructions can also cause the circuitry to indicate to cause the processed FEC payload information for the FEC payload to be routed through the first interconnect interface and through a second interconnect interface via which the network device directly couples with a host computing platform. The processed FEC payload information can be routed through the first and the second interconnect interfaces to enable the FEC accelerator device to write the processed FEC payload information to a memory maintained on the host computing platform.

Example 16. The at least one machine readable medium of example 15, the instructions can also cause the circuitry to: receive configuration information sent from control circuitry of the host computing platform through the second interconnect interface and cause the FEC accelerator device to be configured based on the configuration information to enable the FEC accelerator device to write the processed FEC payload information to the memory maintained on the host computing platform.

Example 17. The at least one machine readable medium of example 16, the configuration information can indicate allocated memory from among the memory maintained on the host computing platform to which the processed FEC information is to be written via a direct memory access operation.

Example 18. The at least one machine readable medium of example 15, the instructions to cause the circuitry to receive the data packet further can also include the instructions to cause the circuitry to receive the data packet from a radio unit and cause the data packet to be received in a memory maintained at the network device.

Example 19. The at least one machine readable medium of example 15, the first and the second interconnect interfaces can be configured to operate according to a PCIe specification.

Example 20. The at least one machine readable medium of example 15, wherein the network device be an IPU or a DPU.

Example 21. An example system can include a host computing platform to include a host memory, a FEC accelerator device, and a network device. The network device can include circuitry to receive a data packet that includes an FEC payload. The circuitry can also indicate to the FEC accelerator device coupled directly with the network device through a first interconnect interface that the FEC payload is to be processed by the FEC accelerator device to generate processed FEC payload information. The circuitry can also cause the processed FEC payload information for the FEC payload to be routed through the first interconnect interface and through a second interconnect interface via which the network device directly couples with the host computing platform. The processed FEC payload information can be routed through the first and the second interconnect interfaces to enable the FEC accelerator device to write the processed FEC payload information to the host memory.

Example 22. The system of example 21 can also include the circuitry to receive configuration information sent from control circuitry of the host computing platform through the second interconnect interface. The circuitry can also cause the FEC accelerator device to be configured based on the configuration information to enable the FEC accelerator device to write the processed FEC payload information to the memory maintained on the host computing platform.

Example 23. The system of example 22, the configuration information can indicate allocated memory from among the memory maintained on the host computing platform to which the processed FEC information can be written via a direct memory access operation.

Example 24. The system of example 21, the circuitry to receive the data packet can also include the circuitry to receive the data packet from a radio unit and cause the data packet to be received in a memory maintained at the network device.

Example 25. The system of example 21, the first and the second interconnect interfaces can be configured to operate according to a PCIe specification.

Example 26. The system of example 21, the network device can be an IPU or a DPU.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A network device comprising:
a network interface configured to receive a data packet that includes a forward error correction (FEC) payload:
a first interconnect interface to couple with a host computing platform;
a second interconnect interface to couple with a FEC accelerator device; and
circuitry configured to:
indicate to the FEC accelerator device through the second interconnect interface that the FEC payload is to be processed by the FEC accelerator device to generate processed FEC payload information; and
cause the processed FEC payload information for the FEC payload to be routed through the second interconnect interface and through the first interconnect interface, wherein the processed FEC payload information is routed through the second and the first interconnect interfaces to enable the FEC accelerator device to write the processed FEC payload information to a memory maintained on the host computing platform.

2. The network device of claim 1, further comprising the circuitry to:
receive configuration information sent from control circuitry of the host computing platform through the first interconnect interface; and
cause the FEC accelerator device to be configured based on the configuration information to enable the FEC accelerator device to write the processed FEC payload information to the memory maintained on the host computing platform.

3. The network device of claim 2, wherein the configuration information indicates allocated memory from among the memory maintained on the host computing platform to which the processed FEC information is to be written via a direct memory access operation.

4. The network device of claim 1, wherein the data packet is received from a radio unit, and wherein the circuitry is further configured to cause the data packet to be received in a memory maintained at the network device.

5. The network device of claim 1, wherein the first and the second interconnect interfaces are configured to operate according to a Peripheral Component Interconnect Express (PCIe) specification.

6. The network device of claim 1, wherein the network device comprises an infrastructure processing unit (IPU) or a data processing unit (DPU).

7. At least one machine readable medium comprising a plurality of instructions that in response to being executed by circuitry of a network device, causes the circuitry to:
receive a data packet that includes a forward error correction (FEC) payload;
indicate to an FEC accelerator device coupled directly with the network device through a first interconnect interface that the FEC payload is to be processed by the FEC accelerator device to generate processed FEC payload information; and
cause the processed FEC payload information for the FEC payload to be routed through the first interconnect interface and through a second interconnect interface via which the network device directly couples with a host computing platform, wherein the processed FEC payload information is routed through the first and the second interconnect interfaces to enable the FEC accelerator device to write the processed FEC payload information to a memory maintained on the host computing platform.

8. The at least one machine readable medium of claim 7, wherein the instructions are to further cause the circuitry to:
receive configuration information sent from control circuitry of the host computing platform through the second interconnect interface; and
cause the FEC accelerator device to be configured based on the configuration information to enable the FEC accelerator device to write the processed FEC payload information to the memory maintained on the host computing platform.

9. The at least one machine readable medium of claim 8, wherein the configuration information indicates allocated memory from among the memory maintained on the host computing platform to which the processed FEC information is to be written via a direct memory access operation.

10. The at least one machine readable medium of claim 7, wherein the instructions to cause the circuitry to receive the data packet further comprises the instructions to cause the circuitry to receive the data packet from a radio unit and cause the data packet to be received in a memory maintained at the network device.

11. The at least one machine readable medium of claim 7, wherein the first and the second interconnect interfaces are configured to operate according to a Peripheral Component Interconnect Express (PCIe) specification.

12. The at least one machine readable medium of claim 7, wherein the network device comprises an infrastructure processing unit (IPU) or a data processing unit (DPU).

13. A system comprising:
a host computing platform to include a host memory;
a forward error correction (FEC) accelerator device; and
a network device, the network device to include circuitry to:
receive a data packet that includes an FEC payload;
indicate to the FEC accelerator device coupled directly with the network device through a first interconnect interface that the FEC payload is to be processed by the FEC accelerator device to generate processed FEC payload information; and
cause the processed FEC payload information for the FEC payload to be routed through the first interconnect interface and through a second interconnect interface via which the network device directly couples with the host computing platform, wherein the processed FEC payload information is routed through the first and the second interconnect interfaces to enable the FEC accelerator device to write the processed FEC payload information to the host memory.

14. The system of claim 13, further comprising the circuitry to:
receive configuration information sent from control circuitry of the host computing platform through the second interconnect interface; and
cause the FEC accelerator device to be configured based on the configuration information to enable the FEC accelerator device to write the processed FEC payload information to the memory maintained on the host computing platform.

15. The system of claim 14, wherein the configuration information indicates allocated memory from among the memory maintained on the host computing platform to which the processed FEC information is to be written via a direct memory access operation.

16. The system of claim 13, wherein the circuitry to receive the data packet comprises the circuitry to receive the data packet from a radio unit and cause the data packet to be received in a memory maintained at the network device.

17. The system of claim 13, wherein the first and the second interconnect interfaces are configured to operate according to a Peripheral Component Interconnect Express (PCIe) specification.

18. The system of claim 13, wherein the network device comprises an infrastructure processing unit (IPU) or a data processing unit (DPU).
